(19) United States
(12) Patent Application Publication
(10) Pub. No.: US 2024/0114404 A1
(43) Pub. Date: Apr. 4, 2024

(54) MASTER NODE, COMMUNICATION APPARATUS, AND COMMUNICATION CONTROL METHOD

(71) Applicants: DENSO CORPORATION, Kariya-city (JP); TOYOTA JIDOSHA KABUSHIKI KAISHA, Toyota-shi (JP)

(72) Inventors: Daiki MAEMOTO, Kariya-city (JP); Hideaki Takahashi, Kariya-city (JP)

(21) Appl. No.: 18/540,587

(22) Filed: Dec. 14, 2023

Related U.S. Application Data
(63) Continuation of application No. PCT/JP2022/025658, filed on Jun. 28, 2022.

(30) Foreign Application Priority Data
Jun. 29, 2021 (JP) 2021-107727

(51) Int. Cl. H04W 36/00

(52) U.S. Cl. CPC H04W 36/0069

(57) ABSTRACT

A master node is connected to a user equipment together with a secondary node using dual connectivity. The master node comprises: a transmitter configured to transmit, to the UE, information indicating to change a primary secondary cell (PSCell) in a state where a secondary cell group associated with the secondary node is deactivated, to transmit an indication to activate the secondary cell group to the UE, and to transmit an indication to deactivate the secondary cell group to the UE after a random access procedure for the changed PSCell is executed.

### CROSS-REFERENCE TO RELATED APPLICATIONS

The present application is a continuation application of international Patent Application No. PCT/JP2022/025658, filed on Jun. 28, 2022, which designated the U.S., and claims the benefit of priority of Japanese Patent Application No. 2021-107727, filed on Jun. 29, 2021, the entire contents of which are incorporated herein by reference.

### TECHNICAL FIELD

The present disclosure relates to a master node, a communication apparatus, and a communication control method used in a mobile communication system.

### BACKGROUND ART

Third Generation Partnership Project (3GPP) (registered trademark; the same applies hereinafter), which is a mobile communication system standardization project, dual connectivity (DC) is introduced.

In the dual connectivity, only one base station (hereinafter, it may be referred to as a “master base station” or a “master node”) among a plurality of base stations establishes radio resource control (RRC) connection with a communication apparatus (user equipment (UE)). On the other hand, among the plurality of base stations, another base station other than the master base station (hereinafter, it may be referred to as a “secondary base station” or a “secondary node”) does not establish the RRC connection with the communication apparatus, and provides additional radio resources to the communication apparatus.

In the dual connectivity, the communication apparatus transmits and receives user data using the radio resources of the secondary node while transmitting and receiving user data using the radio resources of the master node. As a result, the communication apparatus can improve the throughput.

On the other hand, power consumption of the communication apparatus that performs radio communication by the dual connectivity is larger than that in a case of performing the radio communication with one base station.

Therefore, in 3GPP, technology for deactivating a secondary cell group (SCG) managed by the secondary node according to a situation has been studied.

For the deactivation of the SCG, there are, for example, the following agreements in 3GPP. That is, only the master node may generate an RRC message related to activation or deactivation of the SCG, and/or the communication apparatus may indicate, to the master node, that the communication apparatus desires to deactivate the SCG.

On the other hand, in 3GPP, a PSCel change (hereinafter, it may be referred to as the “PS cell change”) is defined. The PS cell is a primary cell of the SCG managed by the secondary node. By the PS cell change, it is possible to switch the secondary node managing the SCG from a source secondary node to a target secondary node. For example, in a case where the communication apparatus moves away from the source secondary node and approaches the target secondary node, the secondary node managing the SCG can be switched to the target secondary node by performing the PS cell change.

In 3GPP, how to perform the PS cell change when the SCG is deactivated is discussed. For example, the following proposal is proposed in 3GPP. That is, it is proposed that the communication apparatus does not perform random access for access to a target PS cell when the SCG is deactivated, in the PS cell change. In addition, it is proposed that the communication apparatus performs random access toward the target PS cell during the PS cell change, in a case where a target SCG is configured as deactivation.

### CITATION LIST

### Non Patent Literature

Non Patent Literature 1: 3GPP TS 37.340 V16.5.0
Non Patent Literature 2: 3GPP Contribution R2-2104315
Non Patent Literature 3: 3GPP Contribution R2-2103977
Non Patent Literature 4: 3GPP Contribution R2-2106023
Non Patent Literature 5: 3GPP Contribution R2-2105829

### SUMMARY OF INVENTION

With respect to the PS cell change when the SCG is deactivated, because the SCG is deactivated, the communication apparatus may not execute a random access procedure on the target secondary node.

When the communication apparatus cannot execute the random access procedure on the target secondary node, the communication apparatus may perform reconnection processing on the secondary node. When a user equipment performs the reconnection processing, power consumption of the communication apparatus increases as compared with a case where the reconnection processing is not performed.

Therefore, an object of the present disclosure is to provide a master node, a communication apparatus, and a communication control method capable of suppressing an increase in power consumption of the communication apparatus.

A master node according to a first feature is connected to a communication apparatus together with a secondary node using dual connectivity. The master node comprises: a transmitter configured to transmit, to the communication apparatus, information indicating to change a primary secondary cell (PSCell) in a state where a secondary cell group associated with the secondary node is deactivated, to transmit an indication to activate the secondary cell group to the communication apparatus, and to transmit an indication to deactivate the secondary cell group to the communication apparatus after a random access procedure for the changed PSCell is executed. A communication apparatus according to a second feature is connected to a master node and connected to a secondary node using dual connectivity. The communication apparatus comprises: a receiver configured to receive, from the master node (200-1), information indicating to change a primary secondary cell (PSCell) in a state where a secondary cell group associated with the secondary node (200-2) is deactivated, to receive an indication to activate the secondary cell group from the master node, and to receive an indication to deactivate the secondary cell group from the master node (200-1) after a random access procedure for the changed PSCell is executed.

A communication control method according to a third feature in a communication apparatus connected to a master node and connected to a first secondary node using dual connectivity. The communication control method comprises the steps of: receiving, from the master node, information indicating to change a primary secondary cell (PSCell) in a state where a secondary cell group associated with the secondary node is deactivated; receiving an indication to activate the secondary cell group from the master node; and receiving an indication to deactivate the secondary cell group from the master node after a random access procedure for the changed PSCell is executed.

### BRIEF DESCRIPTION OF DRAWINGS

The above and other objects, features, and advantages of the present disclosure will become more apparent from the following detailed description with reference to the accompanying drawings. The drawings are as follows.

FIG. 1 is a diagram illustrating a configuration example of a mobile communication system according to an embodiment of the present disclosure.

FIG. 2 is a diagram illustrating a configuration example of a protocol stack according to the embodiment of the present disclosure.

FIG. 3 is a diagram illustrating a configuration example of a protocol stack according to the embodiment of the present disclosure.

FIG. 4 is a diagram illustrating a configuration example of a UE according to the embodiment of the present disclosure.

FIG. 5 is a diagram illustrating a configuration example of a base station according to the embodiment of the present disclosure.

FIG. 6 is a diagram illustrating an example of packet duplication according to the embodiment of the present disclosure.

FIG. 7 is a diagram illustrating an operation example according to the embodiment of the present disclosure.

FIG. 8 is a diagram illustrating an operation example in a specification according to the embodiment of the present disclosure.

FIG. 9 is a diagram illustrating an example of packet duplication according to the embodiment of the present disclosure.

### DESCRIPTION OF EMBODIMENTS

Hereinafter, embodiments of the present disclosure will be described in detail with reference to the drawings. Note that, in the present specification and the drawings, components that can be described in a similar manner are denoted by the same or similar reference numerals, and redundant description can be omitted.

### First Embodiment

(1.1) Configuration Example of Mobile Communication System

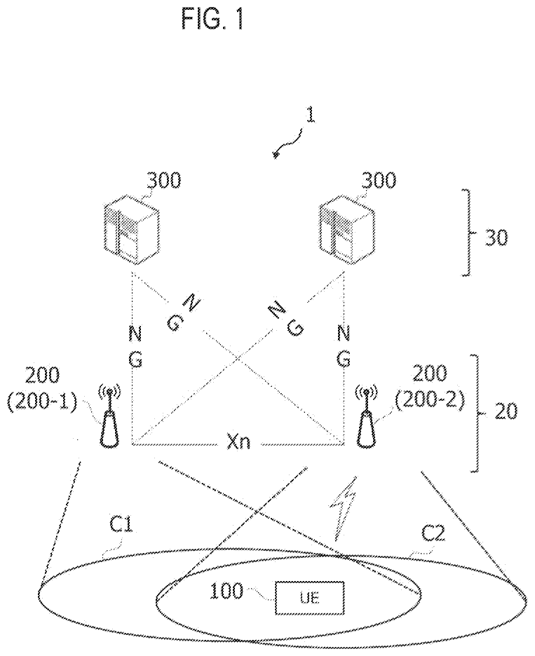

FIG. 1 is a configuration example of a mobile communication system 1 according to an embodiment of the present disclosure. The mobile communication system 1 is, for example, a 5th generation (5G) system of 3GPP. In the mobile communication system 1, the LTE system and the 5G system may be mixed. Further, in the mobile communication system 1, the 5G system and another generation (for example, the sixth generation) may be mixed. The mobile communication system 1 may include a system conforming to a standard other than 3GPP.

As illustrated in FIG. 1, the mobile communication system 1 includes a radio access network (hereinafter, it may be referred to as a next generation radio access network (NG-RAN)) 20, a core network (hereinafter, it may be referred to as a 5G core network (5GC)) 30, and a communication apparatus (hereinafter, it may be referred to as a user equipment (UE)) 100.

The NG-RAN 20 includes a base station (gNB) 200, which is a node of a radio access network.

The base station 200 is a radio communication apparatus that performs radio communication with the UE 100. The base station 200 manages one or a plurality of cells. The base station 200 performs radio communication with the UE 100 that has established RRC connection in its cell. The base station 200 has a radio resource management function, a routing function of user data (hereinafter, it may be simply referred to as “data”), a measurement control function for mobility control and scheduling, and the like.

Note that the “cell” is used as a term indicating a minimum unit of a radio communication area. The “cell” may be used as a term representing a function of performing radio communication with the UE 100 or a term representing a resource. One cell belongs to one carrier frequency. In FIG. 1, a base station 200-1 manages a cell C1, and a base station 200-2 manages a cell C2. Note that the NG-RAN 20 may include a base station 200-3. In this case, a cell C3 of the base station 200-3 has a cell range including an overlapping range of the cell C1 and the cell C2. The UE 100 may exist in an overlapping range of the cell C1, the cell C2, and the cell C3.

The 5GC 30 includes a core network apparatus 300.

The core network apparatus 300 includes an apparatus corresponding to a control plane. In this case, the core network apparatus 300 can perform various types of mobility control on the UE 100 by communicating with the UE 100 using non-access stratum (NAS) signaling. The core network apparatus 300 may be an access management function (AMF) or a mobility management entity (MME).

Further, the core network apparatus 300 includes an apparatus corresponding to a user plane. In this case, the core network apparatus 300 performs transfer control of data of the UE 100. The core network apparatus 300 may be a user plane function (UPF) or a serving gateway (S-GW).

As illustrated in FIG. 1, each of the base stations 200-1 and 200-2 is mutually connected to the 5GC 30 via an interface called an NG interface. In addition, the base stations 200-1 and 200-2 are mutually connected via an interface called an Xn interface.

The UE 100 is, for example, a mobile radio communication apparatus such as a smartphone, a tablet terminal, a personal computer, a communication module, or a communication card. The UE 100 may be a vehicle (for example, a car, a train, or the like) or an apparatus provided in the vehicle. Further, the UE 100 may be a transport body (for example, a ship, an airplane, or the like) or an apparatus provided in the transport body. Furthermore, the UE 100 may be a sensor or an apparatus provided in the sensor. Note that the UE 100 may be used as another name such as a mobile station, a mobile terminal, a mobile apparatus, a mobile unit, a subscriber station, a subscriber terminal, a subscriber apparatus, a remote station, a remote terminal, a remote apparatus, or a remote unit.

Note that FIG. 1 illustrates an example in which the UE 100 exists in both the cell C1 managed by the base station 200-1 and the cell C2 managed by the base station 200-2.

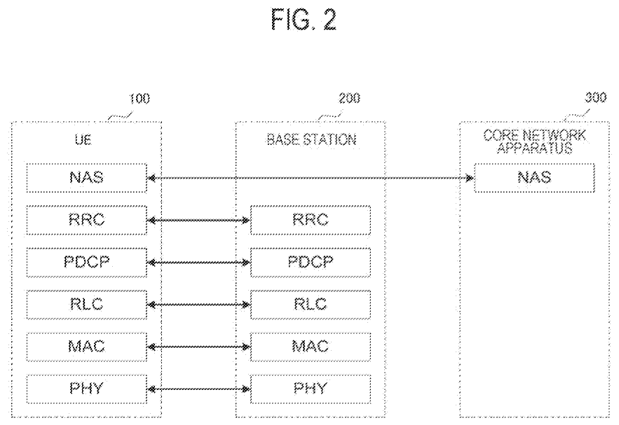

(1.2) Configuration example of protocol stack FIG. 2 is a diagram illustrating a configuration example of a protocol stack according to the embodiment of the present disclosure. FIG. 2 illustrates a configuration example of a protocol stack related to the control plane.

As illustrated in FIG. 2, a physical (PHY) layer, a media access control (MAC) layer, a radio link control (RLC) layer, a packet data convergence protocol (PDCP) layer, and an RRC layer are included in the UE 100 and the base station 200 as protocols related to the control plane. Further, an NAS layer is included in the UE 100 and the core network apparatus 300.

The PHY layer performs encoding and decoding, modulation and demodulation, antenna mapping and demapping, and resource mapping and demapping. Data and control information are transmitted between the PHY layer of the UE 100 and the PHY layer of the base station 200 via a physical channel.

The MAC layer performs priority control of data, retransmission processing by hybrid automatic repeat request (hybrid ARQ (HARM)), and a random access procedure. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size and modulation and encoding scheme) and allocated resource blocks.

The RLC layer transmits data to the RLC layer on a reception side using functions of the MAC layer and the PHY layer. Data and control information are transmitted between the RLC layer of the UE 100 and the RLC layer of the base station 200 via a logical channel.

The PDCP layer performs header compression and decompression and encryption and decryption. Data and control information are transmitted between the PDCP layer of the UE 100 and the PDCP layer of the base station 200 via a radio bearer.

The RRC layer controls a logical channel, a transport channel, and a physical channel according to establishment, reestablishment, and release of the radio bearer. RRC signaling for various configurations is transmitted between the RRC layer of the UE 100 and the RRC layer of the base station 200. When there is RRC connection with the base station 200, the UE 100 is in an RRC connected state. When there is no RRC connection with the base station 200, the UE 100 is in an RRC idle state.

The NAS layer performs session management, mobility management, and the like. NAS signaling is transmitted between the NAS layer of the UE 100 and the NAS layer of the core network apparatus 300.

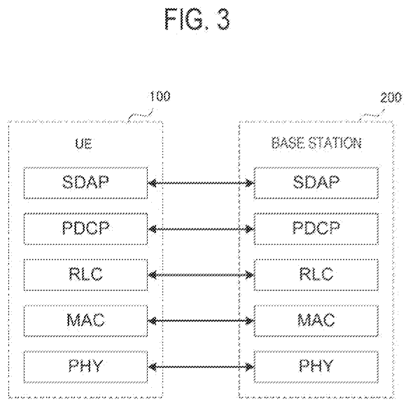

FIG. 3 is a diagram illustrating a configuration example of a protocol stack according to the embodiment of the present disclosure. FIG. 3 illustrates a configuration example of a protocol stack related to the user plane.

As illustrated in FIG. 3, a PHY layer, a MAC layer, an RLC layer, a PDCP layer, and a service data protocol (SDAP) layer are included in the UE 100 and the base station 200 as protocols related to the user plane.

The SDAP layer maps a quality of service (QoS) flow and a data radio bearer, and assigns a QoS flow identification (ID) in both uplink (UL) and downlink (DL).

(1.3) Dual Connectivity

The UE 100 can use resources provided from two different nodes connected by a non-ideal backhaul. In this case, one of the nodes becomes a master node (MN) that manages a master cell group (hereinafter, it may be referred to as the “MCG”). The other node becomes a secondary node (SN) that manages a secondary cell group (hereinafter, it may be referred to as the “SCG”). The master node and the secondary node are connected via the network interface (Xn interface). At least the master node is connected to the core network.

The master node provides a single control plane toward the core network (for example, the 5GC 30). The master node may be referred to as a master evolved node B (eNB), a master new generation-eNB (ng-eNB), or a master gNB.

The secondary node provides additional radio resources to the UE 100 without control plane connection to the core network. The secondary node may be referred to as an en-gNB, a secondary ng-eNB, or a secondary gNB.

Here, the master node and the secondary node are logical entities. In the present embodiment, it is assumed that the master node corresponds to the base station 200-1, and the secondary node corresponds to the base station 200-2, in the following description.

The MCG is a cell group of a serving cell associated with the master node. The MCG has a primary cell (Sp cell or P cell) and has optionally one or more secondary cells (S cells).

The SCG is a group of serving cells associated with the secondary node. The SCG has a primary cell (Sp cell or PS cell) and has optionally one or more secondary cells (S cells). The Sp cell is a primary cell in the MCG and is also a primary cell in the SCG.

The UE 100 can be connected to the secondary node in a case of managing the SCG while being connected to the master node that manages the MCG. In this case, the UE 100 is simultaneously connected to each node to perform radio communication.

Note that the configuration of the dual connectivity is performed by the master node transmitting a predetermined message (for example, an SN Addition Request message) to the secondary node, and transmitting an RRC message (for example, an RRC Reconfiguration message) to the UE 100.

Hereinafter, the base station 200-1 may be referred to as the master node 200-1 or the master base station 200-1. Furthermore, hereinafter, the base station 200-2 may be referred to as the secondary node 200-2 or the secondary base station 200-2. Further, hereinafter, the base station 200-2 may be referred to as a source secondary node 200-2, and the base station 200-3 may be referred to as a target secondary node 200-3.

In the dual connectivity, a PS cell change of the SCG may be performed. By the PS cell change, a MAC entity may be reset, and an RLC entity configured for the SCG may be reestablished. By the PS cell change, a secondary node change procedure may be performed. In the first embodiment, a change procedure of changing the secondary node from the source secondary node 200-2 to the target secondary node 200-3 is performed by the PS cell change. Details will be described in an operation example.

(1.4) Deactivation of SCG

Next, deactivation of the SCG will be described.

In 3GPP, the deactivation of the SCG is considered in order to suppress the power consumption of the UE 100. When the SCG is deactivated, the UE 100 deactivates all cells (PSCell and SCell) belonging to the SCG. The UE 100 does not report channel state information (CSI) for the cells belonging to the deactivated SCG, and also does not monitor a physical downlink control channel (PDCCH). Further, the UE 100 does not transmit a random access channel (RACH), a sounding reference signal (SRS), and/or a UL-shared channel (UL-SCH) to the cell. As a result, the power consumption of the UE 100 is suppressed.

The UE 100 deactivates the SCG by any one of the following methods.

Method 1: The UE 100 deactivates the SCG in response to receiving an indication to deactivate the SCG from the master node (base station 200-1). The indication is transmitted by any one of signaling of the RRC layer (RRC message), signaling of the MAC layer (MAC CE), and signaling of the PHY layer (PDCCH).

Method 2: The UE 100 deactivates the SCG in response to expiration of a timer for deactivating the SCG.

(1.5) Configuration Example of UE

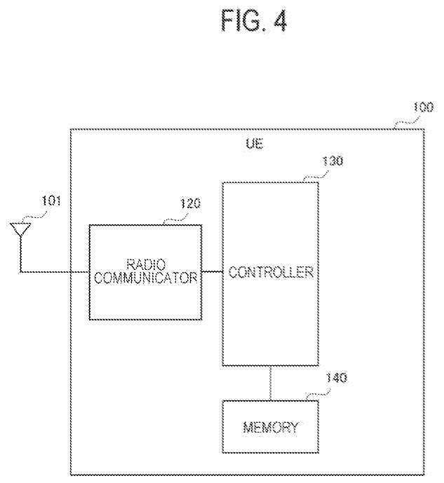

FIG. 4 is a diagram illustrating a configuration example of the UE 100. As illustrated in FIG. 4, the UE 100 has an antenna 101, a radio communicator 120, a controller 130, and a memory 140.

The antenna 101 receives a radio signal transmitted from the base station 200 and outputs the received radio signal to the radio communicator 120. In addition, the antenna 101 transmits the radio signal output from the radio communicator 120 to the base station 200.

The radio communicator 120 performs radio communication with the base station 200 via the antenna 101 under the control of the controller 130. For example, the radio communicator 120 converts (down-converts) the radio signal output from the antenna 101 into a baseband signal (received signal), and outputs the converted baseband signal to the controller 130. Further, for example, the radio communicator 120 converts (up-converts) the baseband signal (transmission signal) output from the controller 130 into a radio signal, and outputs the converted radio signal to the antenna 101.

The controller 130 performs various types of control in the UE 100. The controller 130 controls radio communication with the base station 200 or radio communication with another UE via the radio communicator 120 or the like, for example. The controller 130 may perform various operations by processing the received signal output from the radio communicator 120. Further, the controller 130 may perform various operations and output a transmission signal to the radio communicator 120. The operation of the UE 100 to be described later may be an operation by the controller 130.

The memory 140 stores various types of information and the like under the control of the controller 130. The memory 140 may function as a working memory of the controller 130. Further, the memory 140 may store a program. In this case, the controller 130 realizes the operation in the UE 100 by reading and executing the program from the memory 140. The memory 140 may be a read only memory (ROM) or a random access memory (RAM).

(1.6) Configuration Example of Base Station

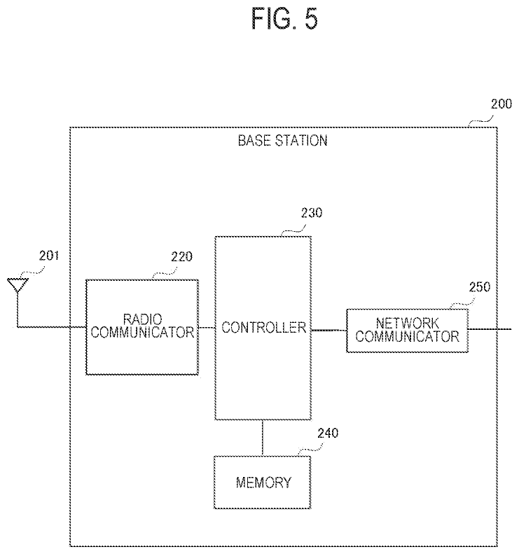

FIG. 5 is a diagram illustrating a configuration example of the base station 200. The base station 200 illustrated in FIG. 5 may be any one of the base stations 200-1 to 200-3.

As illustrated in FIG. 5, the base station 200 has an antenna 201, a radio communicator 220, a controller 230, a memory 240, and a network communicator 250.

The antenna 201 receives the radio signal transmitted from the UE 100 and outputs the received radio signal to the radio communicator 220. In addition, the antenna 201 transmits the radio signal output from the radio communicator 220 to the UE 100.

The radio communicator 220 performs radio communication with the UE 100 via the antenna 201 under the control of the controller 230. For example, the radio communicator 220 converts (down-converts) the radio signal output from the antenna 201 into a baseband signal (received signal), and outputs the converted baseband signal to the controller 230. Further, for example, the radio communicator 220 converts (up-converts) the baseband signal (transmission signal) output from the controller 230 into a radio, and outputs the converted radio signal to the antenna 201.

The controller 230 performs various types of control in the base station 200. The controller 230 controls radio communication with the UE 100 via the radio communicator 220 or the like, for example. The controller 230 may perform various operations by processing the received signal output from the radio communicator 220. Further, the controller 230 may perform various operations and output a transmission signal to the radio communicator 220.

Further, the controller 230 controls communication with the core network apparatus 300 or another base station via the network communicator 250. The controller 230 receives a message or the like transmitted from the core network apparatus 300 or another base station via the network communicator 250, and performs various operations. Further, the controller 230 can transmit various messages from the network communicator 250 to the core network apparatus 300 or another base station by performing various operations and instructing the network communicator 250 to generate and transmit messages.

The operation of the base station 200 described later may be an operation by the controller 230.

The memory 240 stores various types of information and the like under the control of the controller 230. The memory 240 may function as a working memory of the controller 230. Further, the memory 240 may store a program. In this case, the controller 230 realizes the operation in the base station 200 by reading and executing the program from the memory 240. The memory 240 may be a read only memory (ROM) or a random access memory (RAM).

The network communicator 250 can communicate with another base station or each node of the 5GC 30. The network communicator 250 can communicate with another base station using a message of the Xn interface. In addition, the network communicator 250 can communicate with each node of the 5GC 30 using a message of the NG interface.

In the mobile communication system 1 configured as described above, in the first embodiment, the UE 100 has the following configuration. That is, the UE 100 of the first embodiment is connected to the master base station 200-1 and connected to the first secondary base station (for example, the secondary node 200-2) using the dual connectivity. The UE 100 has the controller 130 that activates the PS cell when the PS cell (or the PSCell) is changed from the first secondary base station to the second secondary base station (for example, the secondary node 200-3) in a state where the secondary cell group managed by the first secondary base station is deactivated. Further, the UE 100 has the radio communicator 120 that executes a random access procedure on the second secondary base station in response to the activation of the PS cell.

As described above, when the secondary node is changed from the first secondary node to the second secondary node in a state where the SCG is deactivated, the UE 100 activates the PS cell. As a result, the UE 100 can execute the random access procedure on the second secondary node having the PS cell. Therefore, the UE 100 does not perform the reconnection processing to the second secondary node, and an increase in power consumption of the UE 100 can be suppressed.

(2) Operation Example

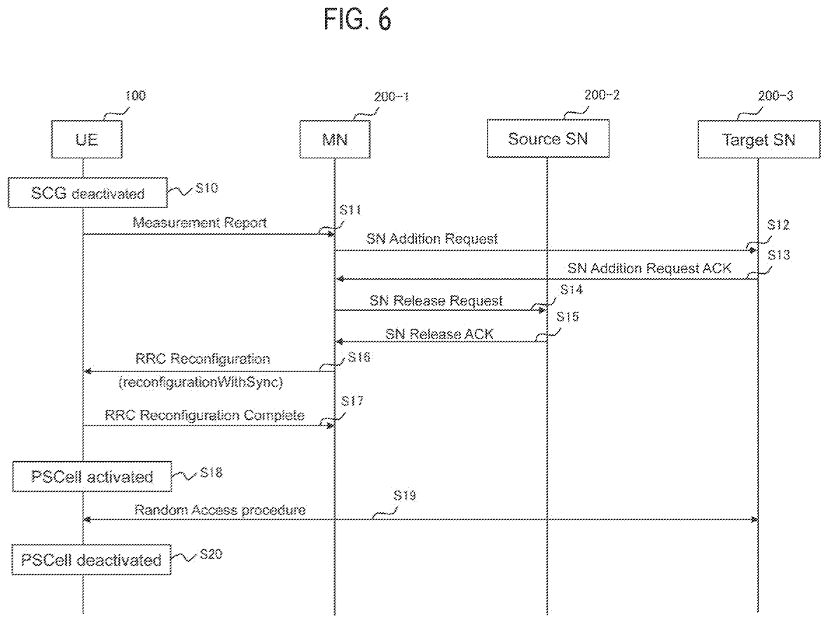

FIG. 6 is a diagram illustrating an operation example according to the embodiment of the present disclosure.

It is assumed that the dual connectivity is configured between the UE 100, the base station 200-1, and the base station 200-2 before processing illustrated in FIG. 6 is initiated.

Hereinafter, the master base station 200-1 may be referred to as a master node (hereinafter, it may be referred to as the “MN”) 200-1. Further, the secondary base station 200-2 may be referred to as a secondary node (hereinafter, it may be referred to as the “SN”) 200-2. Further, the base station 200-2 may be referred to as a source SN 200-2, and the base station 200-3 may be referred to as a target SN 200-3.

As illustrated in FIG. 6, in step S10, the controller 130 of the UE 100 detects that the SCG of the SN 200-2 is deactivated. For example, the controller 230 of the MN 200-1 generates an RRC message indicating that the SCG of the SN 200-2 is deactivated, and transmits the RRC message to the UE 100 via the radio communicator 220. The controller 130 of the UE 100 detects that the SCG of the SN 200-2 is deactivated by receiving the RRC message via the radio communicator 120.

In step S11, the controller 130 of the UE 100 transmits a measurement report to the MN 200-1. For example, the UE 100 transmits the measurement report by satisfying a certain condition, for example, that the received signal strength from the source SN 200-2 becomes lower than a threshold and the received signal strength from the target SN 200-3 becomes higher than the threshold.

In step S12, the controller 230 of the MN 200-1 transmits an SN Addition Request message to the target SN 200-3 in response to reception of the measurement report. The SN Addition Request message is a message requesting addition of an SN.

In step S13, the controller 230 of the target SN 200-3 transmits an SN Addition Request ACK message to the MN 200-1 in response to reception of the SN Addition Request message. The SN Addition Request ACK message is a message indicating that addition to the SN is permitted for the SN Addition Request message.

In step S14, the controller 230 of the MN 200-1 transmits an SN Release Request message to the source SN 200-2 in response to the reception of the SN Addition Request ACK. The SN Release Request message is a message requesting release from the SN.

In step S15, the controller 230 of the source SN 200-2 transmits an SN Release Request ACK to the MN 200-1 in response to reception of the SN Release Request message. The SN Release Request ACK message is a message indicating that release from the SN is permitted for the SN Release Request message.

In step S16, the controller 230 of the MN 200-1 transmits an RRC Reconfiguration message to the UE 100 in response to reception of the SN Release Request ACK message. The RRC Reconfiguration message may include reconfigurationWithSync. The reconfigurationWithSync may be an information element that instructs the UE 100 to perform at least one of the activation of the PS cell (subsequent step S18) and the deactivation of the PS cell (subsequent step S20). Alternatively, the reconfigurationWithSync may include the information element that instructs the UE 100 to perform at least one of the activation of the PS cell (subsequent step S18) and the deactivation of the PS cell (subsequent step S20).

In step S17, when the reconfiguration is performed according to the RRC Reconfiguration message, the controller 130 of the UE 100 transmits an RRC Reconfiguration Complete message to the MN 200-1.

In step S18, the controller 130 of the UE 100 activates the PS cell. That is, the controller 130 of the UE 100 activates the PS cell that is deactivated by the deactivation of the SCG. Specifically, when the SCG managed by the first secondary base station 200-2 is deactivated (step S10) and the PS cell is changed from the first secondary base station 200-2 to the second secondary base station 200-3, the controller 130 activates the PS cell. The controller 130 may activate the PS cell according to an instruction (for example, reconfigurationWithSync) from the MN 200-1. The controller 130 may autonomously activate the PS cell without receiving an instruction from the MN 200-1.

In step S19, the controller 130 of the UE 100 executes a random access procedure. In this case, the controller 130 may execute the random access procedure on the PS cell of the target SN 200-3. The controller 130 executes the random access procedure on the target SN 200-3, so that the UE 100 completes connection to the target SN 200-3.

In step S20, the controller 130 of the UE 100 deactivates the activated PS cell. The controller 130 may deactivate the PS cell according to an instruction (for example, reconfigurationWithSync) from the MN 200-1. The controller 130 may autonomously activate the PS cell without receiving an instruction from the MN 200-1.

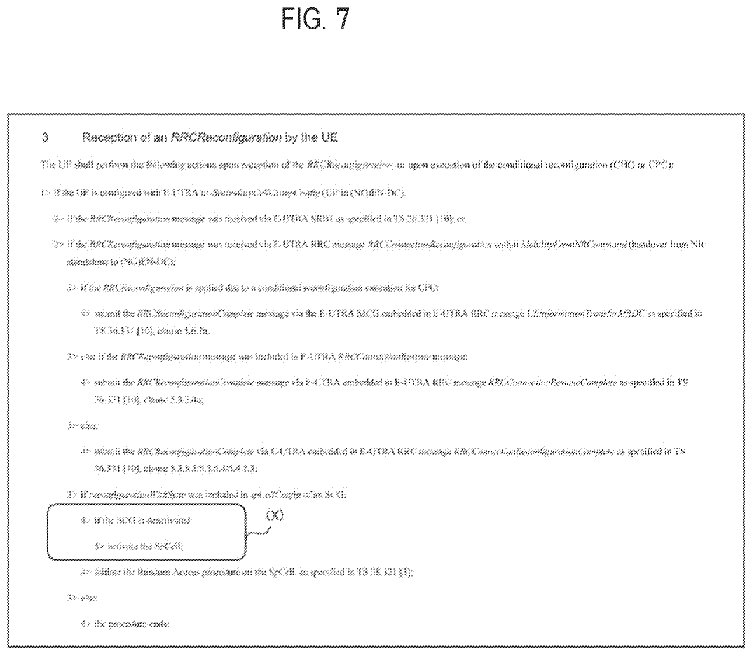

FIGS. 7 to 9 are diagrams illustrating operation examples in specifications according to the embodiment of the present disclosure. Among these, FIG. 7 illustrates an operation example in a case of EN-DC and NGEN-DC. The EN-DC is dual connectivity of an evolved Node B (eNB) and an en-gNB, and is dual connectivity in a case where the eNB that is an MN is connected to an evolved packet core (EPC). In addition, the NGEN-DC is dual connectivity of an ng-eNB and a gNB, and is dual connectivity in a case where the ng-eNB that is an MN is connected to the 5GC. The EN-DC and the NGEN-DC may be collectively referred to as (NG) EN-DC.

That is, FIG. 7 illustrates an example of a case where the dual connectivity according to the (NG) EN-DC is configured and the RRC Reconfiguration message is received, and the RRC Reconfiguration message includes reconfigurationWithSync. As illustrated in (X) of FIG. 7, when the SCG is deactivated, the UE 100 activates the Sp cell. (X) of FIG. 7 corresponds to, for example, step S18 of FIG. 6.

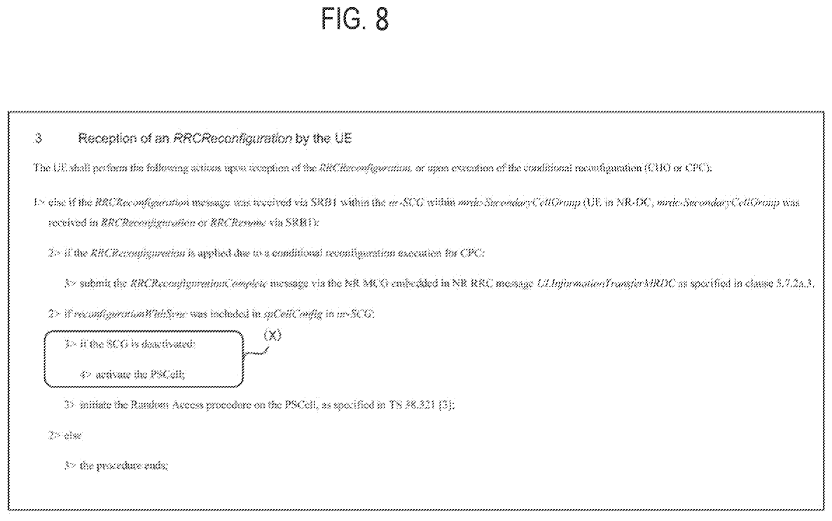

FIG. 8 illustrates an operation example in a case of NR-DC. The NR-DC is dual connectivity between gNBs. In addition, FIG. 8 illustrates an example of a case where the RRC Reconfiguration message is received and the RRC Reconfiguration message includes reconfigurationWithSync. As illustrated in (X) of FIG. 8, when the SCG is deactivated, the UE 100 activates the PS cell. (X) of FIG. 8 also corresponds to, for example, step S18 of FIG. 6.

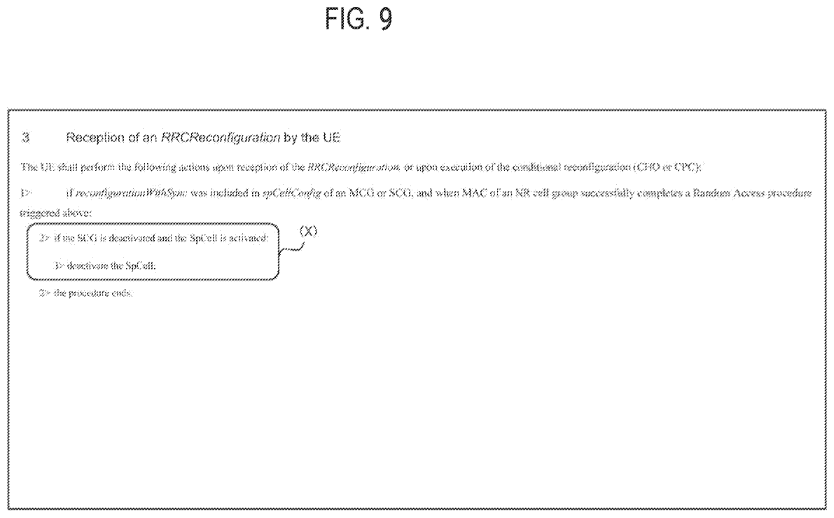

FIG. 9 is an operation example corresponding to S20 of FIG. 6. As illustrated in (X) of FIG. 9, when the SCG is deactivated (for example, S10 in FIG. 6) and the Sp cell is activated (for example, S18 in FIG. 6), the Sp cell is deactivated. Processing of returning the Sp cell activated to execute the random access procedure to the deactivated state which is the original state is performed for the UE 100.

### OTHER EMBODIMENTS

Each operation example described above is not limited to the case of being separately and independently performed, and each operation example can be appropriately combined and performed. Further, for example, the steps in the processing described in the present specification do not necessarily need to be executed in time series in the order described in the flowchart or the sequence diagram. For example, the steps in the processing may be executed in the order different from the order described as the flowchart or the sequence diagram, or may be executed in parallel. Also, some of the steps in the processing may be deleted, and further steps may be added to the processing.

Furthermore, for example, a method that includes the operation of one or more components of the apparatus described in the present specification may be provided, and a program for causing a computer to execute the operation of the components may be provided. The program may be recorded on a computer-readable medium. If the computer-readable medium is used, the program can be installed in the computer. Here, the computer-readable medium on which the program is recorded may be a non-transitory recording medium. The non-transitory recording medium is not particularly limited, but may be, for example, a recording medium such as a CD-ROM or a DVD-ROM. As an example of such a recording medium, there are the above-described memories 140 and 240.

Furthermore, a circuit that executes each processing to be performed by the UE 100 or the base station 200 may be integrated, and at least a part of the UE 100 or the base station 200 may be configured as a semiconductor integrated circuit (chipset or SoC).

Although the present disclosure has been described in accordance with examples, it is understood that the present disclosure is not limited to the examples and structures. The present disclosure also includes various modification examples and modifications within an equivalent range. In addition, various combinations and modes, and other combinations and modes including only one element, more elements, or less elements are also within the scope and idea of the present disclosure.

1. A master node configured to connected to a secondary node associated with a secondary cell group and a communication apparatus, the master node comprising:
a transmitter configured to transmit a radio resource control (RRC) message to the communication apparatus, and
a controller configured to control, based on transmission of the RRC message including information indicating the deactivation of the secondary cell group, the communication apparatus to perform deactivation of the secondary cell group, wherein
the controller is configured to control, based on transmission of the RRC message including information indicating change of a primary secondary cell of the secondary cell group, the communication apparatus to perform activation of the primary secondary cell and a random access procedure in the primary secondary cell.

2. A communication apparatus configured to connected to a secondary node associated with a secondary cell group and a master node, the communication apparatus comprising:
a receiver configured to receive a radio resource control (RRC) message, and
a controller configured to perform deactivation of the secondary cell group based on reception of the RRC message including information indicating the deactivation of the secondary cell group, wherein
the controller is configured to perform activation of a primary secondary cell and a random access procedure in the primary secondary cell based on reception of the RRC message including information indicating change of the primary secondary cell of the secondary cell group.

3. A communication method executed by a communication apparatus configured to connected to a secondary node associated with a secondary cell group and a master node, the communication method comprising:
receiving a radio resource control (RRC) message;
performing deactivation of the secondary cell group based on reception of the RRC message including information indicating the deactivation of the secondary cell group; and
performing activation of a primary secondary cell and a random access procedure in the primary secondary cell based on reception of the RRC message including information indicating change of the primary secondary cell of the secondary cell group.
